(19) United States
(12) Patent Application Publication
(10) Pub. No.: US 2011/0137673 A1
(43) Pub. Date: Jun. 9, 2011

(54) HEALTHCARE PROVIDER RESOURCES ONLINE

(76) Inventors: BRIAN BURK, HILLSBOROUGH, NJ (US); JASON VARZAREVSKY, MANALAPAN, NJ (US)

(21) Appl. No.: 12/797,654

(22) Filed: Jun. 10, 2010

Related U.S. Application Data
(60) Provisional application No. 61/268,500, filed on Jun. 12, 2009.

(51) Int. Cl. G06Q 50/00; G06Q 10/00

(52) U.S. Cl. 705/2

(57) ABSTRACT

The present invention discloses a system and a method for providing and managing promotional and informational resources provided by drug manufacturers to HCPs. An HCP assistance system is disclosed having a static information repository with an information component that manipulates information recorded within the static information repository. HCP accessing the present invention are required to authenticate their membership in the system as well as their good standing with a licensing body. This authentication is performed within a presentation component that can be accessed via global computer network (GCN). An information component also provides an HCP with access to available drug samples, and any objective factual information related to a treatment, as well as any resources provided by pharmaceutical manufacturers to assist indigent patients. Additionally the system allows an HCP to participate in surveys and provide feedback to drug manufacturers, as well as to solicit or to decline future visits by sales representatives of a given drug manufacturer. Also disclosed is a preferred method for carrying out the present invention.

### CLAIM OF PRIORITY

This application claims the priority of U.S. Ser. No. 61/268,500 filed on Jun. 12, 2009, the contents of which are fully incorporated herein by reference.

### FIELD OF THE INVENTION

The invention relates to a system and method for contacting and requesting products and other services from pharmaceutical manufacturers by healthcare professionals (HCPs).

### BACKGROUND OF THE INVENTION

The invention relates to providing objective and promotional information to healthcare providers regarding drugs and other drug related information. Currently, this information is available to healthcare providers by the drug manufacturers' themselves, and by their representatives. However, what is currently available is only pertinent to that manufacturer. The narrow presentation that is currently prevalent in the art is unsatisfactory, since it requires an HCP to seek out and communicate with many disconnected centers of information that may have conflicting and otherwise insufficient informational content. While online drug information databases are known, there is a need to aggregate pharmaceutical factual and promotional information and provide a means for requesting resources and facilitating knowledge exchange. An HCP in the present invention refers to a physician, a physician assistant, a nurse, a nurse practitioner, a patient, or anyone else involved in the healthcare industry.

There are numerous drug manufacturers in the US and around the world, and each has dozens of products that treat a broad range of preventive care and illnesses. To stay competitive, drug manufactures are feverishly working at developing new treatments and are incessantly promoting new drugs for new and existing conditions. Given the crowded industry and sophistication of the available offerings, it is incumbent on HCPs to be informed and to research the gamut of available treatments. However, for some HCPs, who have no convenient access to promotional pharmaceutical information, staying informed is a challenge.

Presently, drug manufactures use a variety of methods to promote their products. One of typical methods is through the help of a sales team. However, not all HCP are covered equally by pharmaceutical representatives. An HCP may be overlooked by a sales team if he or she practices in a remote location, or if the sales team is insufficiently represented in a particular HCP's area, or if treatment activities by a particular HCP do not amount to a level sufficient in justifying direct contact by a sales team. Therefore, such an HCP may find it difficult to find relevant information, drug samples, and access to various other information. In addition, some HCPs have irregular office hours, or they complete all of their prescription work in the evening, after seeing patients, when a visit by a sales representative is highly unlikely. For this reason the HCP requires an alternative means of accessing pharmaceutical information supplied by representative, yet no satisfactory means currently exists. There is a need for a single place where objective information about pharmaceutical resources, for example, products, samples and communications can be obtained with out the need to visit a multitude of different sources.

### DESCRIPTION OF THE RELATED ART

U.S. Pat. No. 5,628,530 teaches a method and system for collectively tracking demographics of healthcare provider (12,14) prescribed starter drug samples dispensed to a plurality of patients (18,20) from a plurality of different dispensing locations (38,40) employs a multipart product specific sample drug voucher, such as a smart card (100) or a preprinted two part voucher (102), which has a marketing information portion (30,34) and a separable prescription portion (32,36) to be completed by the prescribing healthcare provider with starter drug sample quantity and dosage information along with patient demographic information. The prescription portion (32,36) is segregated from the marketing information portion (30,34) at the pharmacy (38,40) either electronically by a card reader (112), if it had been encoded on a smart card (100) by the healthcare provider (12,14), or physically by separation along a perforation (50), if recorded on a two part voucher (102), and is electronically retrievably stored in the pharmacy computer (130) from where this tracking information is electronically transmitted to a central remote computer (134), such as at the drug manufacturer, for subsequent rapid market analysis (136).

U.S. Pat. No. 5,799,981 discloses a marketing device and system which enables a company or a designated representative to communicate with other persons involved in the marketing and administration of medical products, including the physician, the patient and the pharmacist. The marketing device comprises multiple, separable segments. These segments can include a product information segment to be affixed to a patient's chart; a disease state management segment to be affixed to a patient's chart; a mailer segment to be returned to the manufacturer of a product or to the manufacturer's representative including patient-related information and, if desired, instructions to the pharmacist to dispense, without charge to the recipient, a specified quantity of a medical product; a pharmacist receipt segment to be signed by the recipient of the free product; a bank check segment made payable to an endorsing pharmacist; a pair of prescription segments; a product sample segment and a patient-education segment for providing information to the patient regarding the disease being treated and/or the prescribed product.

U.S. Patent Application Publication No. 20020065683 teaches a system provides a web site through which physicians can access information about multiple drugs provided by multiple drug companies. A user is authenticated as being a registered physician before being allowed access to the system. The system provides an interactive on-line detail or marketing presentation of a drug. The interactive detail provides information about a drug in addition to requesting and receiving responses or input from the user participating in the interactive detail. Questions and challenges are presented to the user to reinforce concepts, such as a drug's mechanism of action, that are presented to the user during the detail. Users' responses to interactive details are accumulated and provided to the respective drug companies that sponsor the details. As an incentive, the system provides an honorarium or gift to targeted users upon completion of interactive presentations.

Various implements are known in the art, but fail to address all the problems solved by the invention described herein. One embodiment of this invention is illustrated in the accompanying drawings and will be described in more detail herein below.

### SUMMARY OF THE INVENTION

The present invention discloses a system and a method for providing and managing promotional and informational resources provided by drug manufacturers to HCPs. An HCP assistance system is disclosed having a static information repository with an information component that manipulates information recorded within the static information repository. HCP accessing the present invention are required to authenticate their membership in the system as well as their good standing with a licensing body. This authentication is performed within a presentation component that can be accessed via global computer network (GCN). An information component also provides an HCP with access to available drug samples, and any objective factual information related to a treatment, as well as any resources provided by pharmaceutical manufacturers to assist indigent patients. Additionally the system allows an HCP to participate in surveys and provide feedback to drug manufacturers, as well as to solicit or to decline future visits by sales representatives of a given drug manufacturer. Also disclosed is a preferred method for carrying out the present invention.

Therefore, the present invention succeeds in conferring the following, and other not mentioned, desirable and useful benefits and objectives.

It is an object of the present invention to provide a resources system to HCPs.

It is another object of the present invention to provide HCPs with a way to request drug samples and other drug related information.

Yet another object of the present invention is to provide HCPs with means of requesting or declining any future calls by a sales representative.

Still another object of the present invention is to provide HCPs with means of requesting patient education materials regarding available treatments and drugs.

Still another object of the present invention is to provide a means by which an HCP may request indigent patient support from drug manufacturers.

Yet another object of the present invention is to provide an HCP with means of managing his or her privacy in an objective non-pressured environment, through, for example shielding the HCP identity and contact information and the HCP prescribing activity.

Still another object of the present invention is to provide HCP with means of leaving feedback for manufacturers and to participate in various surveys polls.

### BRIEF DESCRIPTION OF THE DRAWINGS

FIG. 1 shows a diagram of the overall preferred embodiment of the present invention.

FIG. 2 shows a detailed flow diagram of a part of the present invention.

FIG. 3 shows a detailed flow diagram of a part of the present invention.

FIG. 4 shows a flow diagram of the disclosed method of the present invention.

FIG. 5 shows a preferred embodiment of the software component of the present invention, including the equipment used by a user of the present invention to access the GCN.

FIG. 6 shows a description of the preferred offline or background processes executed by the present invention.

FIG. 7 shows an illustration of exemplary Access & Services Groups.

FIG. 8 is a flow chart illustrating a preferred embodiment of the Partner Single Sign On Process.

FIG. 9 is a flow chart illustrating a preferred embodiment of the process of making Requests to Manufacturers.

FIG. 10 is a flow chart illustrating a preferred embodiment the process of requests related to Privacy and Communications.

FIG. 11 is a flow chart illustrating a preferred embodiment of the process of requests related to Industry Research.

FIG. 12 is a flow chart illustrating a preferred embodiment of the Validation Logic process.

FIG. 13 is a flow chart illustrating a preferred embodiment of the Validation Process.

FIG. 14 is a flow chart illustrating a preferred embodiment of the Decile Limitation Logic and Process.

FIG. 15 is a flow chart illustrating a preferred embodiment of the Checkout process.

### DETAILED DESCRIPTION

The embodiments of the present invention will now be described with reference to the drawings. Identical elements in the various figures are identified with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

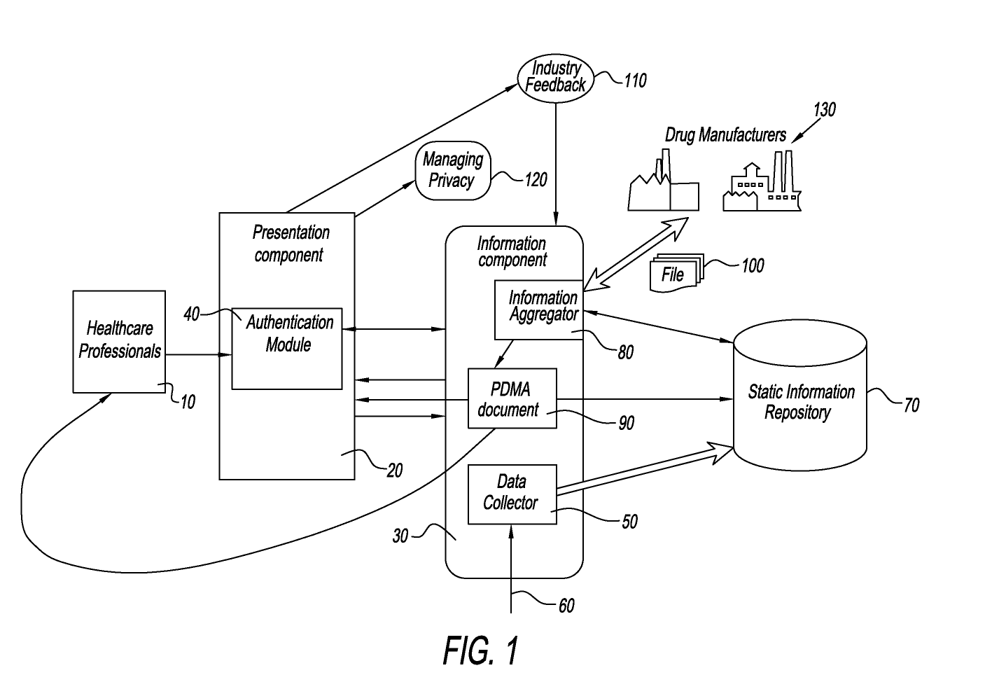

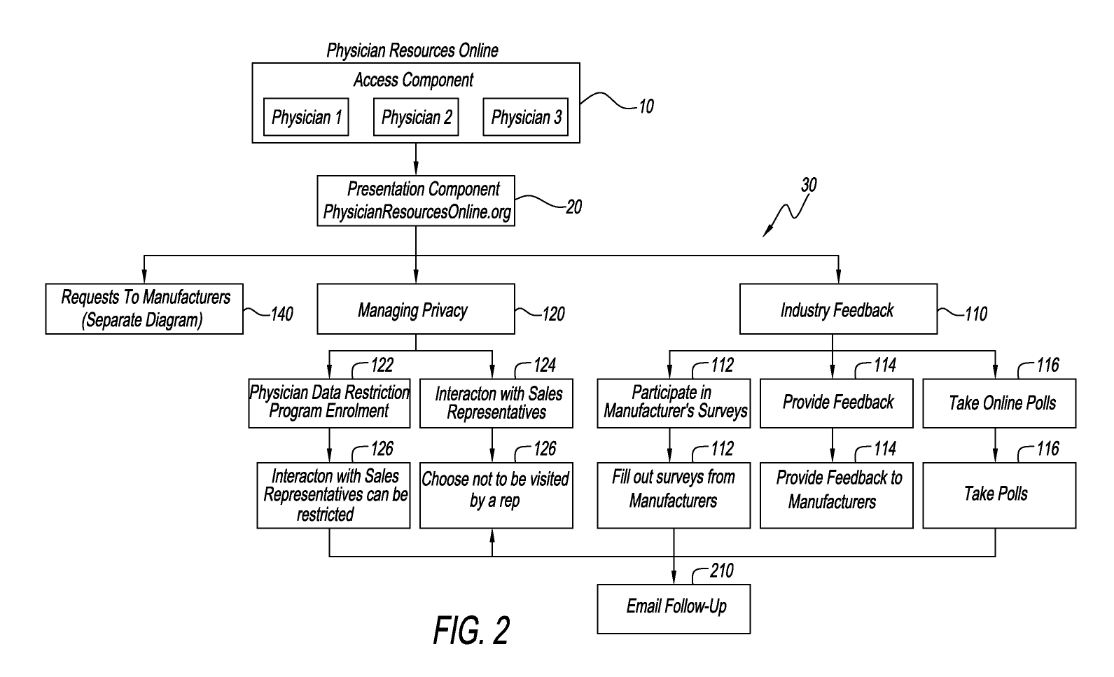

FIG. 1 displays the diagram of the overall invention. Some of the numbered components are described in more detail in FIGS. 2-5. Shown are a session component 10, a presentation component 20, an information component 30, an authentication module 40, a data collector 50, an external information source 60, a static information repository 70, an information aggregation 80, a PDMA compliant document 90, a selection file 100, a feedback component 110, a privacy component 120, and pharmaceutical manufacturers 130.

An HCP initiates a session component 10 by accessing the presentation component 20. A session component enables the presentation component 20 to track HCP's activity and selections, so that residual selections are not lost while the presentation component 20 updates the presentation in response to prompts and selections from the HCP. An HCP in the present invention refers to a physician, a nurse, a nurse practitioner, a patient, or anyone else involved in the medical industry.

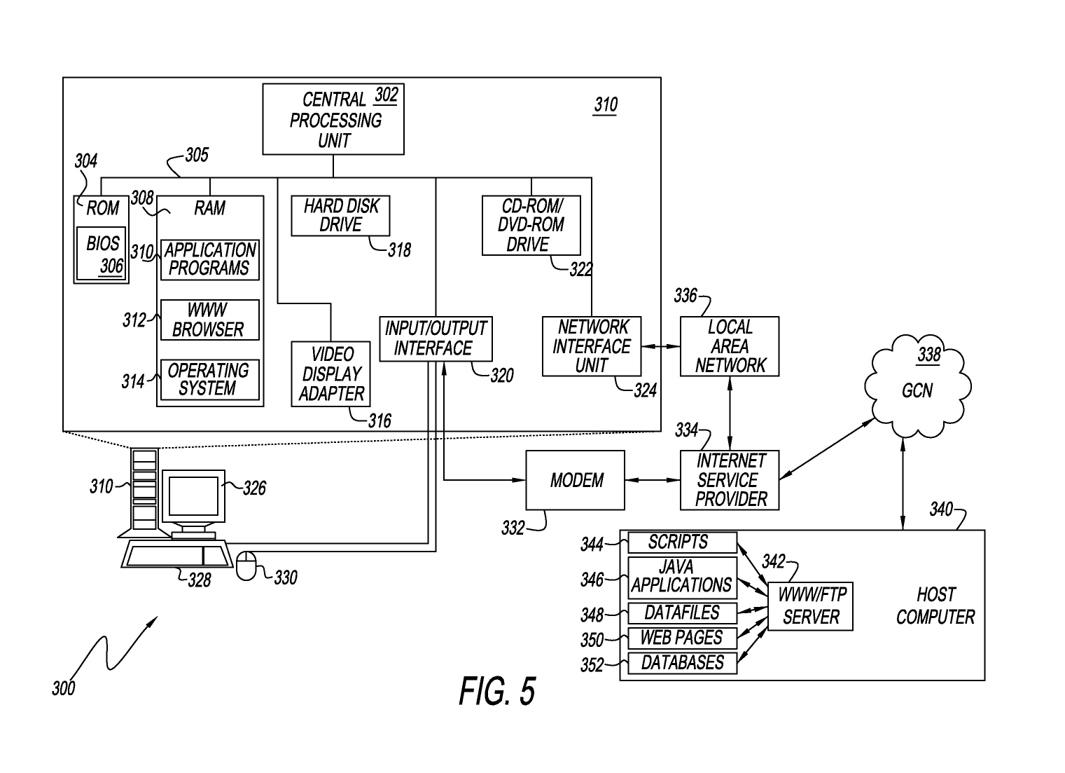

The presentation component 20 visually renders the present invention. Preferably, the presentation component is an electronic portal located on the Global Computer Network (GCN) 338 (FIG. 5). The presentation component 20 is also used to present information to HCPs in a fast, convenient and self-explanatory fashion.

It should be noted that the present invention is not used to solicit HCPs with pharmaceutical promotional information and does not contain interactive models designed to perpetuate such promotional activity by pharmaceutical manufacturer or their representatives. Whether an HCP is aware of existence of any given product is not relevant to the present invention and user's comprehension of any given product is not verified, and is otherwise irrelevant. The present invention serves the health care community and is not a promotional tool. Still referring to FIG. 1, upon entering the presentation level 20, a user, preferably an HCP, is presented with a set of offerings than can be selected with a click of a mouse 330 (FIG. 5). The information thus selected is processed at the information component 30. Once processed, an appropriate response is sent back to the requesting HCP. And, as will be explained later, in some instances, some or all of the selections entered by the requesting HCP are forwarded to a pharmaceutical manufacturer 130 in form of an electronic file 100.

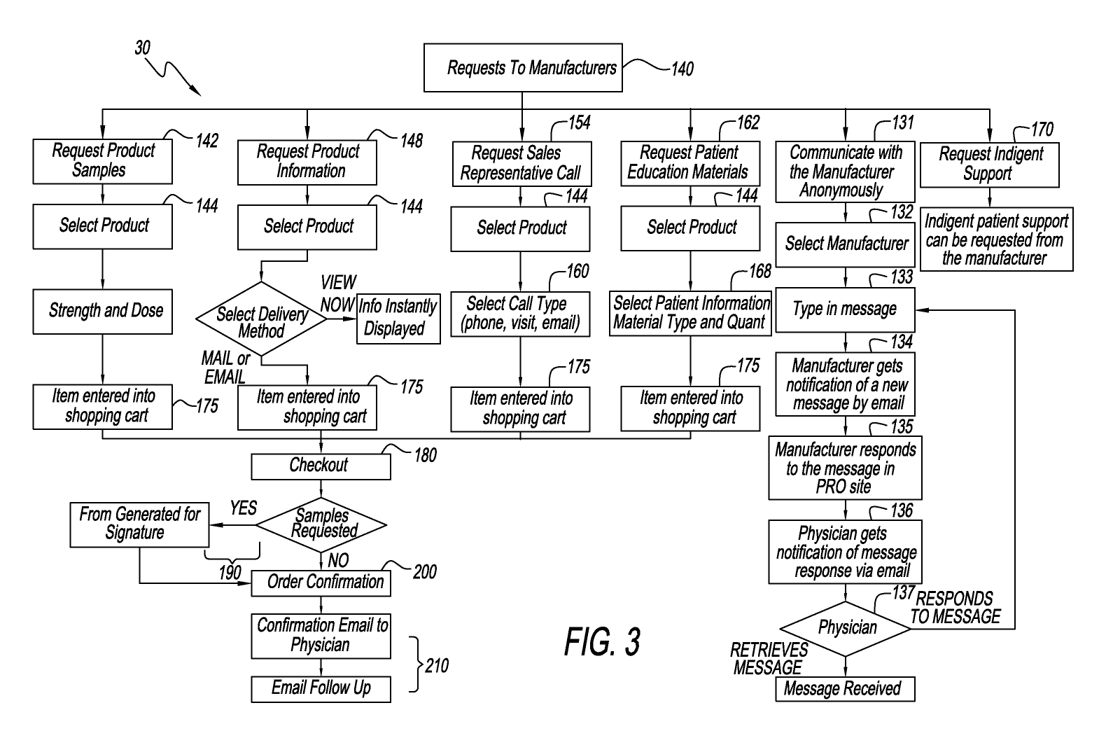

FIG. 1 further shows that upon entering the presentation level 20, an HCP is able to access the feedback component 110 to provide or to review industry feedback about a product, manufacturer, treatment, or another HCP. Preferably, an HCP will also be able to specify the desired level of personal isolation from the pharmaceutical industry with the help of the privacy component 120. Finally, in the preferred embodiment an HCP will be able to ask a question, or will be able to request available drug samples that are located by following a hierarchical relationship of choices, traversed by locating a manufacturer, and/or locating a condition, and/or then locating a product designed to treat this condition and specifying the intensity of treatment. The hierarchies presented can be embodied in a more sophisticated manner, if the medical reality of a condition or a particular healthcare sub-industry so requires. The hierarchical relationship is explained in more detail in FIGS. 2 and 3. The preferred means of retaining an HCP's selections is to place them into an electronically rendered shopping cart 175 (FIG. 3). A shopping cart 175 is a tool to select and retain products while continuing to browse available selections. The final confirmatory step comes with checkout 180.

To finalize selections, an HCP is prompted to either authenticate him or herself within an authentication module 40, or to use the authentication module 40 to register oneself as a new user. Some of the information needed to authenticate an HCP is obtained by a data collector 50 from an external information source 60 and some comes from entries by an HCP, such as address, name, login identifier and password. The external information source 60 can be a live or static feed from one or several accreditation or licensing bodies that are apprised of a purported HCP's standing and certification. An examples of information obtained in this fashion are an AMA number, a DEA number, a license number, an NPI number or an IMS number. One skilled in the art will be able to appreciate that any unique identifier that is objectively assigned and unique to an HCP can be used for authentication purposes.

Once successfully authenticated, the contents of the authenticated HCP's shopping cart 175 are passed through a checkout 180. At this point an HCP's selections are aggregated by an information aggregator 80. The main function of the information aggregator 80 is to gather selection for each individual HCP and organize them by pharmaceutical manufacturer 130 and by product selection 152. A selection file 100 containing this aggregated data is generated at regular intervals and sent electronically over the GCN 338 to pharmaceutical manufacturers 130. Each individual HCP also receives a confirmation 200 in form of a confirmatory email 210 (FIG. 3). If an HCP requested a drug sample, information aggregator 80 compiles a PDMA compliant document 90 for each sample, or if appropriate, for multiple samples that contains all of the statutorily required, and manufacturer required selection and request language, pharmaceutical manufacturer's contact information, and a signature line. The information aggregator 80 obtains this information from the static information repository 70. The static information repository 70 obtains this information from the data collector 50, which in turn receives it from an external information source 60, which includes statutory sources, regulatory sources and manufacturer requirement sources. The static information repository 70 is preferably a relational database. It should be noted that the present invention, and for that matter all components of it, such as a shopping cart 175 and the checkout 180 may be used by anyone, however the drug sample requests and other information not useful to an ordinary user will be stripped from the presentation rendered to an ordinary user.

The static information repository 70 preferably contains all relevant factual drug information such as, but not limited to a drug manufacturer information, statutorily required drug disclosure information, test results data, any promotional program information, any required statutory information, patient education materials, indigent patient support information, form document information, privacy information or any other relevant information.

A PDMA compliant document complies with The Prescription Drug Marketing Act (PDMA) of 1987, which establishes legal safeguards for prescription drug distribution, to ensure safe and effective pharmaceuticals. It's designed to discourage the sale of counterfeit, adulterated, misbranded, sub-potent, and expired prescription drugs.

FIG. 2 is a detailed diagram of the internal processes embodied in the present invention. Shown are a session component 10; a presentation component 20; and an information component 30; a feedback component 110, that includes survey participation 112, feedback provision 114, and poll participation 116; a privacy component 120, that includes a physical data restriction program enrollment 122, an interaction with sales representatives 124, and a contact restriction level 126; a request to pharmaceutical manufacturers 140; and confirmatory (follow-up) email 210.

This diagram shows that the session component 10 can be initiated concurrently by multiple HCPs. Each individual HCP's information does not get lost of mislaid because the session component 10 assists the presentation component 20 in tracking activities of each user.

FIG. 2 discloses that at the presentation level 10 an HCP is presented with an uncluttered and streamlined view of selections. At this point an HCP is guided by a hierarchical relationship among similar components. This provides the ability to present the HCP with a simple starting choice of three or more main topics. These topics expand into further selections that contain sub-topics. At each level, a user is guided intuitively, based on descriptive topic names to the ultimate target selection. This method eliminates the need for key strokes, therefore permitting an HCP to utilize the present invention both on a personal computer, described in FIG. 5, or with a handheld communicator with GCN 338 enabled capabilities. Typically, hand-held devices are ill suited for applications requiring extensive keyboard entries by users, whereas mouse clicks can be easily mimicked and are simpler to use.

In an embodiment diagramed in FIG. 2 an HCP is started off with three choices: a request to a pharmaceutical manufacturer 140, a privacy component 120, and a feedback component 110. The privacy component 120 and a feedback component 110 are further expanded to illustrate the hierarchically based steps an HCP would take to reach the desired selection or setting.

In the privacy component 120, an HCP is able to specify his or her level of isolation from the promotional activities carried out by pharmaceutical industry. Therefore, within a physician data restriction enrolment program 122, an HCP can custom tailor the level of promotional activity he or she is willing to tolerate. If a promotional or informational visit from a sales representative is desired, an HCP can request it within the interaction with sales representative selection 124. At this step, an HCP can further chose whether interaction should be in person or by utilizing a less direct means with the help of a contact restriction level 126. The requesting HCP's selections are placed in an electronic shopping cart 175, for later checkout 180. Additionally, at this point an HCP is notified of selections at confirmatory email 210. All HCP's selections within the feedback component 110, or privacy component 120 or a request to pharmaceutical manufacturer 140 are provisionally stored within the static information repository 70. The contents of the electronic shopping cart 175 (FIG. 3) are also provisionally or permanently stored within the static information repository 70.

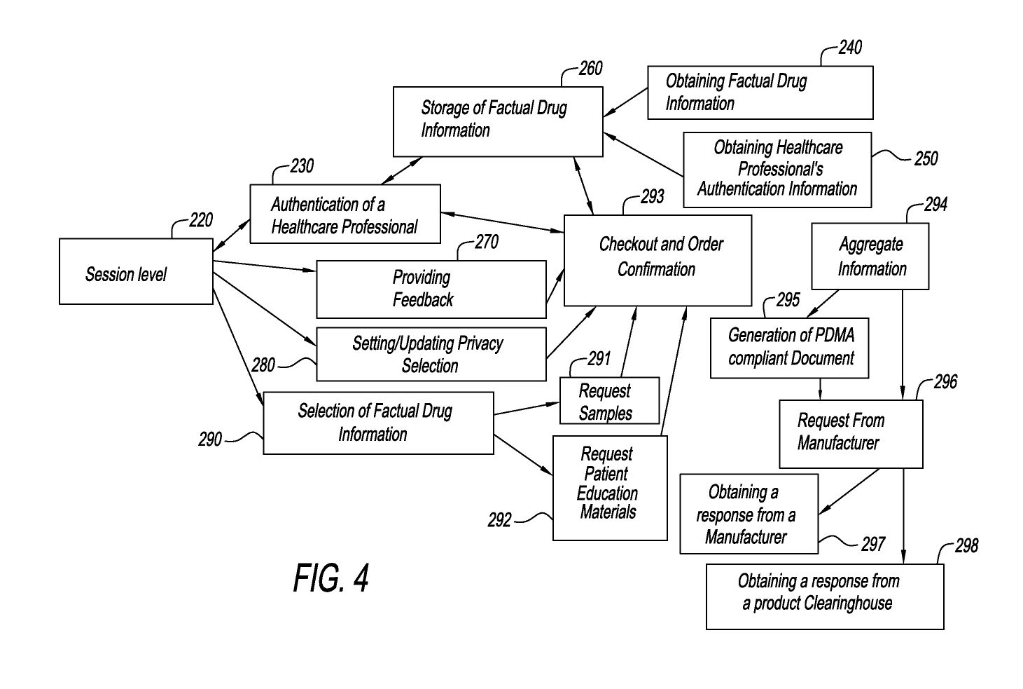

The present invention is a tool geared for HCP's and at those interacting with the healthcare industry in general, and is not a static portal provided by manufactures 130. For this matter, extensive menu driven configuration capabilities (not shown) for user preferences are provided. The user preferences are stored within the static information storage 70 and are presented to an HCP upon successful completion of the authentication step 230 (FIG. 4).

FIG. 3 is a continuation of FIG. 2 in that it further explodes a request to pharmaceutical manufacturers 140 selection. Shown is a request from pharmaceutical manufacturers 140, which further expands into a request for product samples 142 that includes a product selection 144, and a strength and dose selection 146; a request product information 148 which expands into a product selection 144, and a delivery method selection 154; a request for a contact from pharmaceutical representative 156 which further expands into a product selection 144, and a contact type selection 160; a request for patient education materials 162, which further expands into a product selection 144, and a manual type and quantity, strength or dose selection 168; an Anonymous Communication with Manufacturer 131, which expands into a Manufacturer selection 132, a Message type selection 133, an Email of message to manufacturer 134, a Manufacturers response 135, a Physician notified of the response 136, and a Physician reply to the response from Manufacturer 137; and a request indigent patient support 170. A request for indigent patient support 170 is designed to invoke the assistance of promotional and community relations services, that are run by pharmaceutical manufacturers as means of promoting their image and their products, to assist needy patients. FIG. 3 further discloses that all selections listed above end up in an electronic shopping cart 175 and then proceed to checkout 180. Sometimes, as in instances where a drug sample is requested, a PDMA compliant document generation 190 takes place. Such a PDMA compliant document 90 is sent to a requesting HCP and is preferably in a PDF format, or any format commonly used in the art. To further verify that all selections are correct, an HCP needs to confirm with the order confirmation 200, which generates a confirmatory email 210.

It will be appreciated by the participants in the art that the tasks associated with Anonymous Communication with Manufacturer 131 is often a necessity in the art. Some HCP, would like to maintain anonymity for professional or personal reasons when asking information, especially if the information is of a highly sensitive nature. Additionally, some HCPs, and in particular other users, wish to post an isolated narrow query to a drug manufacturer 130, but do not wish to be placed on the general mailing for other information. This forum provides an anonymous, and perhaps more frank, exchange between the various players in the industry, preferably between HCPs and the drug manufacturers 130.

It should be noted that while an HCP has completed the session and may leave, there remain unfinished tasks that must be completed to generate the desired results for the requesting HCP. The information component 20 aggregates the selections from the requesting HCP and adds them to the information file 100 that is going to be sent to manufacturers 130. One skilled in the art will appreciate that the information file 100 may be dispatched in using any conventional means available for this purpose, such as, but not limited to, electronic mail, telephonic or electronic fax, a publisher and subscriber communicating within a GCN 338 enabled setting. Each manufacturer 130 receives only the file containing information that is pertinent to it and its products. In the case of a product sample request 142, the information file 100 will contain a notice that a specific HCP or a group of HCPs have requested a sample. However, an official request for the product samples is not generated until an HCP forwards a signed copy of the PDMA compliant document 90 to the appropriate pharmaceutical manufacturer or agent130. All of the activity and transactions along with any transaction status information may be stored in the static information repository 70 for later reference.

It should also be noted that the various hierarchical selections listed above can be further expanded to include a greater detail or additional functions. The overall focus of the present invention is to present pertinent information in an efficient unbiased manner, therefore additional menu items are added in a way that does not undermine this central guideline.

FIG. 4 describes a method of procuring drug samples from manufactures, requesting educational material, or indigent support, as well as for specifying privacy and for leaving feedback. One skilled in the art will appreciate that the order of steps can be interchanged in some instances. One skilled in the art will further appreciate that the present method can be utilized outside the healthcare industry, by other kinds of professional services, who need information or samples concerning non-health related products.

FIG. 4 discloses the steps of a session level step 220, an authentication step 230, a step of obtaining factual drug information 240, a step of obtaining healthcare professional authentication information 250, a step of storage of factual drug information 260, a step of providing feedback 270, a step of setting up or updating privacy selection 280, a step of selection of factual drug information 290, a step of requesting samples 291, a step of requesting patient education materials 292, a checkout and order confirmation step 293, a step of aggregation of information 294, a step of generation of a PDMA compliant document 295, a step of requesting from manufacturer 296, a step of obtaining response from a manufacturer 297, and a step of obtaining a response from a product clearinghouse 298.

When obtaining factual drug information 240, the present invention relies on an external information source 60, and on prior selections by this HCP. It should be noted that the external information source 60 may include information received from manufacturers 130 and other product related information that may update the static information repository 70 at regular intervals. Another step that requires information obtained from an external information source 60 is authentication information step 250. In this step the static information repository 70 combines an HCP authentication data received from an external information source 60, such as a licensing body, with data stored locally that was generated when an HCP attempted to authenticate for the first time at an authentication step 230. If this information is in good order and matches the current inputs, then the HCP has been authenticated and may proceed to the advance steps, such as checkout and order confirmation 293. It should be noted that only an HCP who is a physician may apply for drug samples, other healthcare professionals, such as physician assistants, nurses, or nurse practitioners, will most likely need to associate themselves with a physician or a healthcare provider facility before qualifying for a sample request. This association will be verified at the authentication step 230 in cases where the requesting HCP is a nurse, a nurse practitioner or other non-physician individual involved with healthcare industry. It should be noted, that an ordinary, non-healthcare professional user will also be able to utilize the present invention. However, such use will be limited to information that does not include drug samples or other information that may be misused by an ordinary user. The authentication step 230 is fully capable of distinguishing among different users and will be able to allow content commensurate with one using the present invention, or in an alternative embodiment, different websites may be developed for different communities of users, such as one for doctors and other prescribers, a second site for nurses, a third site for patients, etc. The static information repository 70 may also contain state and Federal law information, which either permits or prohibits anyone other than a physician to request drug samples. At the authentication step 230 this information would be correlated and verified for each respective requesting HCP.

The step of generation of a PDMA compliant document 295 only occurs when a drug sample is requested. A static information repository 70 is engaged in this step in order to compile appropriate data. An HCP is required so sign a PDMA compliant document 90 and forward it to an appropriate pharmaceutical manufacturer or agent in step 297.

The static information repository 70 is also queried while compiling any supplemental privacy information specified by an HCP or the pharmaceutical manufacturer 130. This step occurs at the confirmatory email step 210. Depending on user preference settings explained in FIG. 2, an HCP is frequently prompted to update privacy settings with a similar confirmatory email step 210, which is set to fire off automatically, at regular intervals as directed by the information component 30. It may be beneficial to an HCP to set limit the contact restriction level 126 and benefit from promotional and informational literature released by manufacturers and their representatives.

The pharmaceutical manufacturer or agent130 is not the only body capable of providing requested information. The information may be provided under a license or a middleman type of agreement from a clearinghouse that deals with products of this kind. The provider of the service embodied in the present invention may be such a clearinghouse, and offer a one-stop-shopping model, where samples, privacy settings, feedback and other product information and promotional program data (such as indigent patient support 170) are retained, managed and distributed. Other entities are also envisioned, such sources as Physicians Desk Reference and similar services.

FIG. 5 and the following discussion are intended to provide a brief, general description of a suitable computing environment in which the invention may be implemented. Referring now to FIG. 5, an illustrative environment for implementing the invention includes a conventional personal computer 300, including a processing unit 302, a system memory, including read only memory (ROM) 304 and random access memory (RAM) 308, and a system bus 305 that couples the system memory to the processing unit 302. The read only memory (ROM) 304 includes a basic input/output system 306 (BIOS), containing the basic routines that help to transfer information between elements within the personal computer 300, such as during start-up. The personal computer 300 further includes a hard disk drive 318 and an optical disk drive 322, e.g., for reading a CD-ROM disk or DVD disk, or to read from or write to other optical media. The drives and their associated computer-readable media provide nonvolatile storage for the personal computer 300. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 308, including an operating system 314 and one or more application programs 310, such as a program for browsing the world-wide-web, such as WWW browser 312. Such program modules may be stored on hard disk drive 318 and loaded into RAM 308 either partially or fully for execution.

A user may enter commands and information into the personal computer 300 through a keyboard 328 and pointing device, such as a mouse 330. Other control input devices (not shown) may include a microphone, joystick, game pad, satellite dish, scanner, or the like. These and other input devices are often connected to the processing unit 300 through an input/output interface 320 that is coupled to the system bus, but may be connected by other interfaces, such as a game port, universal serial bus, or firewire port. A display monitor 326 or other type of display device is also connected to the system bus 305 via an interface, such as a video display adapter 316. In addition to the monitor, personal computers typically include other peripheral output devices (not shown), such as speakers or printers. The personal computer 300 may be capable of displaying a graphical user interface on monitor 326.

The personal computer 300 may operate in a networked environment using logical connections to one or more remote computers, such as a host computer 340. The host computer 340 may be a server, a router, a peer device or other common network node, and typically includes many or all of the elements described relative to the personal computer 300. The LAN 336 may be further connected to a GCN service provider 334 (“ISP”) for access to the GCN 338. In this manner, WWW browser 312 may connect to host computer 340 through LAN 336, ISP 334, and the GCN 338. Such networking environments are commonplace in offices, enterprise-wide computer networks, intranets and the GCN.

When used in a LAN networking environment, the personal computer 300 is connected to the LAN 336 through a network interface unit 324. When used in a WAN networking environment, the personal computer 300 typically includes a modem 332 or other means for establishing communications through the GCN service provider 334 to the GCN. The modem 332, which may be internal or external, is connected to the system bus 305 via the input/output interface 320. It will be appreciated that the network connections shown are illustrative and other means of establishing a communications link between the computers may be used.

The operating system 314 generally controls the operation of the previously discussed personal computer 300, including input/output operations. In the illustrative operating environment, the invention is used in conjunction with Microsoft Corporation's “Windows 98” operating system and a WWW browser 312, such as Microsoft Corporation's GCN Explorer or Netscape Corporation's GCN Navigator, operating under this operating system. However, it should be understood that the invention can be implemented for use in other operating systems, such as Microsoft Corporation's “WINDOWS 3.1,” “WINDOWS 95”, “WINDOWS NT”, “WINDOWS 2000”, “WINDOWS XP” and “WINDOWS VISTA” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc. Likewise, the invention may be implemented for use with other WWW browsers known to those skilled in the art.

Host computer 340 is also connected to the GCN 338, and may contain components similar to those contained in personal computer 300 described above. Additionally, host computer 340 may execute an application program for receiving requests for WWW pages, and for serving such pages to the requestor, such as WWW server 342. According to an embodiment of the present invention, WWW server 342 may receive requests for WWW pages 350 or other documents from WWW browser 312. In response to these requests, WWW server 342 may transmit WWW pages 350 comprising hyper-text markup language (“HTML”) or other markup language files, such as active server pages, to WWW browser 312. Likewise, WWW server 342 may also transmit requested data files 348, such as graphical images or text information, to WWW browser 312. WWW server may also execute scripts 344, such as CGI or PERL scripts, to dynamically produce WWW pages 350 for transmission to WWW browser 312. WWW server 342 may also transmit scripts 344, such as a script written in JavaScript, to WWW browser 312 for execution. Similarly, WWW server 342 may transmit programs written in the Java programming language, developed by Sun Microsystems, Inc., to WWW browser 312 for execution. As will be described in more detail below, aspects of the present invention may be embodied in application programs executed by host computer 342, such as scripts 344, or may be embodied in application programs executed by computer 300, such as Java applications 346. Those skilled in the art will also appreciate that aspects of the invention may also be embodied in a stand-alone application program.

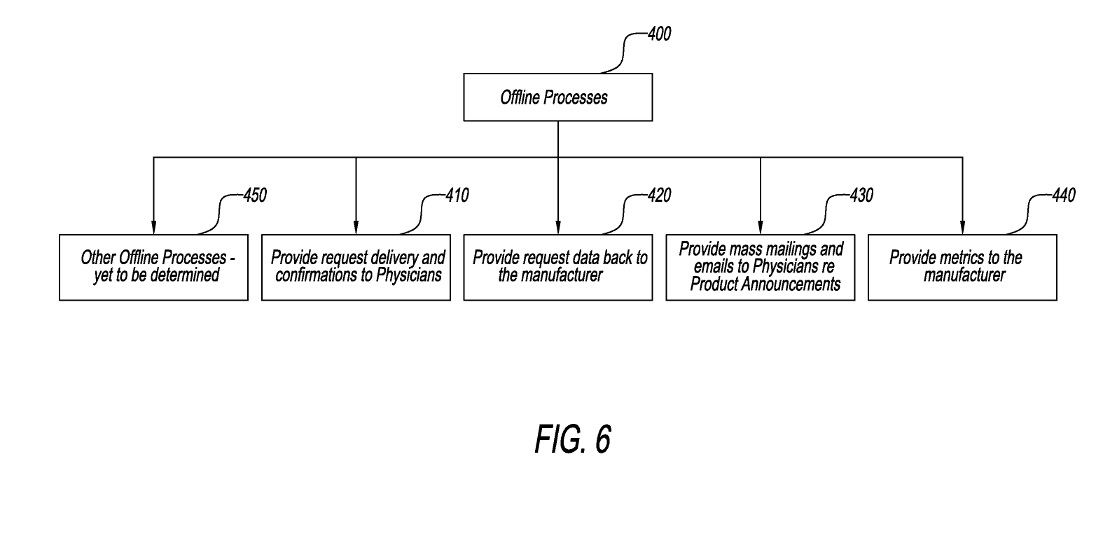

FIG. 6 describes various offline, after-hours and background functions that are preferably carried out by a system embodied in the present invention for the purposes of house keeping or enhancement. Tasks shown are offline processes 400, provide request delivery and confirmation to physicians 410, provide request data back to the manufacturer 420, provide product announcement mailings to physicians 430, provide manufacturer with metrics 440, miscellaneous offline processes 450.

The provide request for delivery and confirmation to physicians 410 is a process that ensures reliable communication between users of the present invention, primarily an HCP, and drug manufacturers and their agents. It ensures that confirmatory emails 210 are sent to physicians and other tasks, such as, but not limited to a message to manufacturer 134, a manufacturers response 135, a physician notified of the response 136, a physician reply to the response from manufacturer 137, and a request indigent patient support 170, are received by all pertinent parties.

The provide request data back to the manufacturer task 420 allows manufactures to request information directly from HCPs and in general allows a community of users that is utilizing the present invention to contact each other and each other's publicly available feedback data.

The provide product announcement mailings to physicians task 430, provides an ability of the present invention to automatically distribute most up-to-date announcement and promotional materials from the drug manufacturers and their agents. Although, this mailing can be limited by HCPs or other users with a privacy setting 120, these messages are generally highly relevant and desirable, since HCPs are kept in the loop about important and developing information about the treatments and products they are using or consuming.

The provide manufacturer with metrics task 440, permits manufacturers to preview metrics from sources such as feedback component 110 or basic demand or interest in products, expressed by HCPs or other users or consumers of a product. Finally the miscellaneous offline processes task 450, provides many household and housekeeping tasks that go along with a system having this level of sophistication. Those skilled in the art will be able to appreciate that most of the individual tasks and steps must be able to communicate with each other, must not conflict over system and application resources and must be able to be spacially aware of each other. These are some, but not all, of the tasks provided by miscellaneous offline processes tasks 450.

The present in invention may be enabled via the GCN 338 as described above. It may also be internal, server based 340 a localized at a healthcare facility. Because of a substantial amount of product and authentication data required, and the expense associated with such acquisition, the healthcare facility would need to be fairly large. The upside of a localized embodiment is increased access control, increased level of privacy and further adaptations of existing configurations. However, smaller scale use by other HCPs will mimic the present invention as described in the figures.

### DESCRIPTION OF THE PREFERRED EMBODIMENTS

The preferred embodiments of the present invention will now be described with reference to the drawings.

### Access & Services Groups:

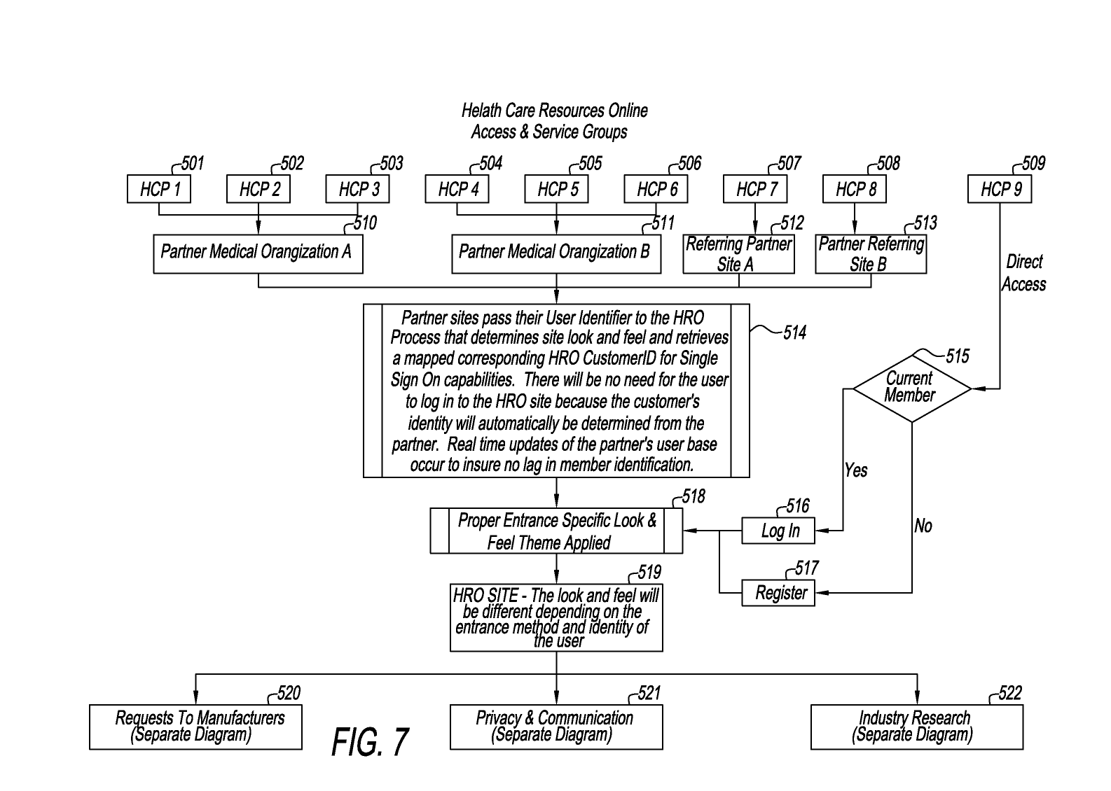

FIG. 7 shows an illustration of exemplary Access & Services Groups. As depicted in FIG. 7, HCP 1 (501), HCP 2 (502) and HCP 3 (503) comprise Partner Medical Organization A (510); HCP 4 (504), HCP 5 (505) and HCP 6 (506) comprise Partner Medical Organization B (511); HCP 7 (507) comprises Referring Partner Site A (512); HCP 8 (508) comprises Partner Referring Site B (513). As depicted in step (514), each of the aforementioned Partner sites pass their User Identifier to the HRO Process that determines site look and feel and retrieves a mapped corresponding HRO CustomerID for Single Sign On capabilities. There will be no need for the user to log in to the HRO site because the customer's identity will automatically be determined from the partner. During step (514), real time updates of the partner's user base occur to insure no lag in member identification.

Alternatively, two routes of direct access are also possible as depicted for HCP 9 (509). First, if a user is a current member (515), they will be able to log in directly, as depicted in step (516). If the user is not a current member then the user may register with the site to gain direct access, as depicted in step (517).

Once proper entrance is granted to the user, specific look and feel theme(s) are applied for the user, as depicted in step (518). It is noted that the look and feel of the HRO Site will be different depending on the entrance method and identity of the user, as depicted in step (519).

Once access is gained to the HRO site, the user may conduct the following activities: 1) make Requests to Manufacturers, as depicted in step (520) [and as illustrated in Figure B]; make selections regarding privacy and communication, as depicted in step (521); or access industry research, as depicted in step (522).

### Partner Single Sign On Process:

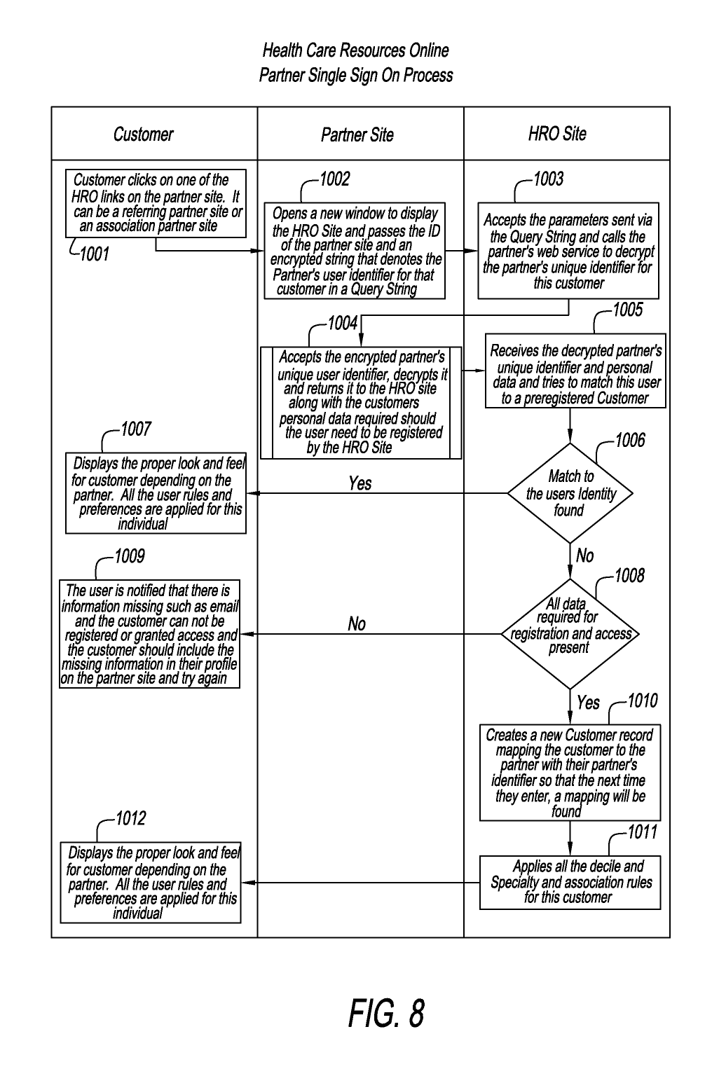

FIG. 8 is a flow chart illustrating the Partner Single Sign On Process. As shown in FIG. 8, the customer/user clicks on one of the HRO links on the Partner Site, as depicted in step (1001). As noted in step (1001), the partner site can be a referring partner site or an association partner site. The partner site opens a new window to display the HRO Site and passes the ID of the partner site and an encrypted string that denotes the Partner's user identifier for that customer in a Query String, as depicted in step (1002). The HRO site accepts the parameters sent via the Query String and calls the partner's web service to decrypt the partner's unique identifier for the customer/user, as depicted in step (1003). The Partner site accepts the encrypted partner's unique user identifier, decrypts it and returns it to the HRO site along with the customer/user's personal data required should the user need to be registered by the HRO site, as depicted in step (1004). The HRO site receives the decrypted partner's unique identifier and personal data and tries to match this user to a preregistered customer/user, as depicted in step (1005). If a match to the user's identity is found, as depicted in step (1006), the HRO site displays the proper look and feel for the customer/user depending on the partner, as depicted in step (1007). As depicted in step (1007), all the user rules and preferences are applied for this customer/user. If a match to the user's identity is not found, the system determines whether all of the data required for registration and access is present for the user, as depicted in step (1008). If all of the data required for registration and access for the user is not present, the user is notified that there is information missing and that the customer/user can not be registered or granted access, as depicted in step (1009). During step (1009), the customer/user is directed to include the missing information in their profile on the partner site and try again. If all of the data required for registration and access for the user is present, the HRO Site creates a new Customer record mapping the customer/user to the partner with their partner's identifier so that the next time they enter, a mapping will be found, as depicted in step (1010). The HRO Site also applies all the information regarding decile, specialty and association rules for the customer/user, as depicted in step (1011). The HRO site displays the proper look and feel for the customer/user depending on the partner, as depicted in step (1012). All the user rules and preferences are applied for this customer/user, as depicted in step (1012).

### Requests to Manufacturers:

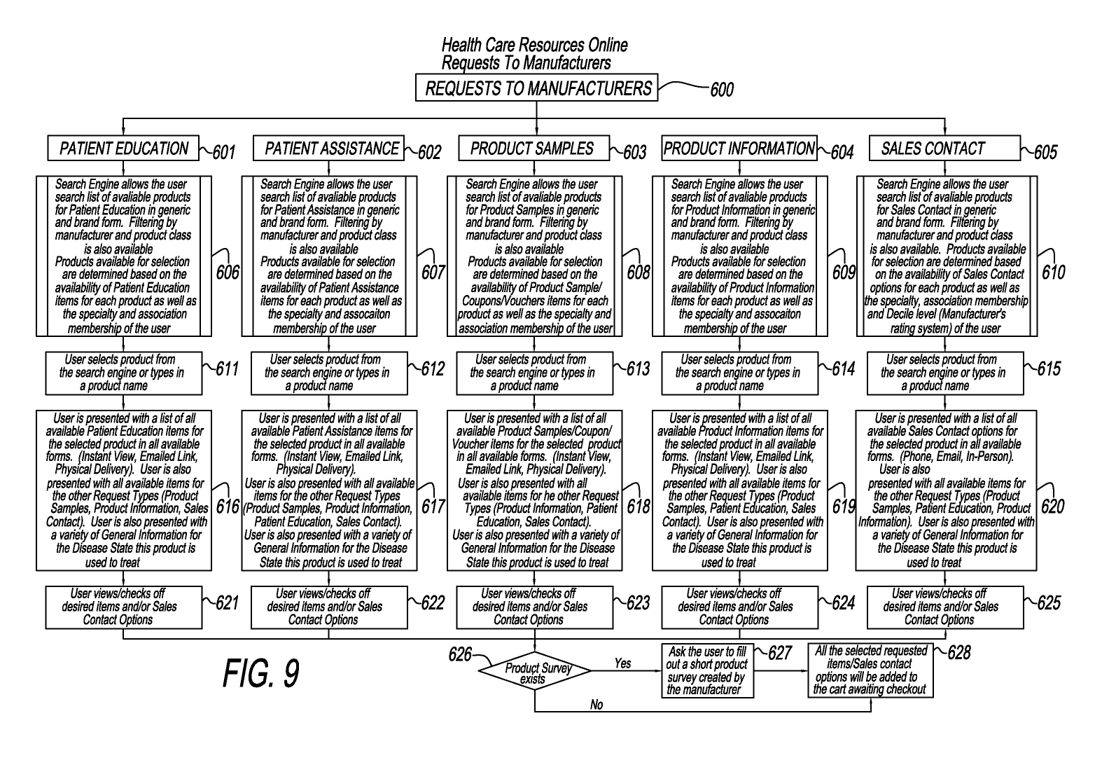

FIG. 9 is a flow chart illustrating an embodiment of the process of making Requests to Manufacturers. As shown in FIG. 9, the user may make Requests to Manufacturers (600) including requests for: materials related to Patient Education (601), materials related to Patient Assistance (602), make requests for Product Samples (603), Product Information (604) or Sales contact (605).

In making requests for materials related to Patient Education (601), the search engine allows the user to search lists of available products for Patient Education in generic and brand form, as depicted in step (606). As noted in step (606), filtering by manufacturer and products class is also available. Products available for selection are determined based on the availability of Patient Education items for each product as well as the specialty and association membership of the user, as depicted in step (606). The user selects products from the search engine or types in a product name, as depicted in step (611). As depicted in step (616), the user is presented with a list of all available Patient Education items for the selected products in all available forms, including but not limited to, instant view Emailed Link and Physical Delivery. The User is also presented with all available items for the other Request Types (Product Samples, Product Information, Sales Contact), as depicted in step (616). During step (616), the user may also be presented with a variety of General Information for the Disease State this product is used to treat. The user views or checks off the desired items and or Sales Contact Options, as depicted in step (621). Lastly, if a product survey exists (626), the user is asked to fill out a short product survey created by the manufacturer, as depicted in step (627). Upon completion of the product survey, all selected requested items/Sales Contact options will be added to the cart awaiting checkout by the user, as depicted in step (628). If no product survey exists (626), all selected requested items/Sales Contact options will be added to the cart awaiting checkout by the user, as depicted in step (628).

In making requests for materials related to Patient Assistance (602), the search engine allows the user to search lists of available products for Patient Assistance in generic and brand form, as depicted in step (607). As noted in step (607), filtering by manufacturer and products class is also available. Products available for selection are determined based on the availability of Patient Assistance items for each product as well as the specialty and association membership of the user, as depicted in step (607). The user selects products from the search engine or types in a product name, as depicted in step (612). The user is presented with a list of all available Patient Assistance items for the selected products in all available forms, including but not limited to, Instant View Emailed Link and Physical Delivery, as depicted in step (617). The User is also presented with all available items for the other Request Types (Product Samples, Product Information, Patient Education, Sales Contact), as depicted in step (617). The user is also presented with a variety of General Information for the Disease State this product is used to treat. The user views or checks off the desired items and or Sales Contact Options, as depicted in step (622). Lastly, if a product survey exists (626), the user is asked to fill out a short product survey created by the manufacturer, as depicted in step (627). Upon completion of the product survey, all selected requested items/Sales Contact options will be added to the cart awaiting checkout by the user, as depicted in step (628). If no product survey exists (626), all selected requested items/Sales Contact options will be added to the cart awaiting checkout by the user, as depicted in step (628).

In making requests for materials related to Product Samples (603), the search engine allows the user to search lists of available products for Product Samples in generic and brand form, as depicted in step (608). As noted in step (608), filtering by manufacturer and products class is also available. Products available for selection are determined based on the availability of Product Sample/Coupons/Vouchers items for each product as well as the specialty and association membership of the user, as depicted in step (608). The user selects products from the search engine or types in a product name, as depicted in step (613). The user is presented with a list of all available Product Samples/Coupon/Voucher items for the selected products in all available forms, including but not limited to, Instant View, Emailed Link and Physical Delivery, as depicted in step (618). The User is also presented with all available items for the other Request Types (Product Information, Patient Education, Sales Contact), as depicted in step (618). The user may also be presented with a variety of General Information for the Disease State this product is used to treat, as depicted in step (618). The user views or checks off the desired items and or Sales Contact Options, as depicted in step (623). Lastly, if a product survey exists (626), the user is asked to fill out a short product survey created by the manufacturer, as depicted in step (627). Upon completion of the product survey, all selected requested items/Sales Contact options will be added to the cart awaiting checkout by the user, as depicted in step (628). If no product survey exists (626), all selected requested items/Sales Contact options will be added to the cart awaiting checkout by the user, as depicted in step (628).

In making requests for materials related to Product Information (604), the search engine allows the user to search lists of available products for Product Information in generic and brand form as depicted in step (609). As noted in step (609), filtering by manufacturer and products class is also available. Products available for selection are determined based on the availability of Product Information items for each product as well as the specialty and association membership of the user, as depicted in step (609). The user selects products from the search engine or types in a product name, as depicted in step (614). The user is presented with a list of all available Product Information items for the selected products in all available forms, including but not limited to, Instant View, Emailed Link and Physical Delivery, as depicted in step (619). The User is also presented with all available items for the other Request Types (Product Samples, Patient Education, Sales Contact), as depicted in step (619). The user may also presented with a variety of General Information for the Disease State this product is used to treat, as depicted in step 619. The user views or checks off the desired items and or Sales Contact Options, as depicted in step (624). Lastly, if a product survey exists (626), the user is asked to fill out a short product survey created by the manufacturer, as depicted in step (627). Upon completion of the product survey, all selected requested items/Sales Contact options will be added to the cart awaiting checkout by the user, as depicted in step (628). If no product survey exists (626), all selected requested items/Sales Contact options will be added to the cart awaiting checkout by the user, as depicted in step (628).

In making requests for Sales Contacts (605), the search engine allows the user to search lists of available products for Sales Contacts in generic and brand form, as depicted in step (610). Filtering by manufacturer and products class is also available during step 610. Products available for selection are determined based on the availability of Sales Contact options for each product as well as the specialty, association membership and Decile level (Manufacturer's rating system) of the user, as depicted in step (610). The user selects products from the search engine or types in a product name, as depicted in step (615). The user is presented with a list of all available Sales Contact options for the selected products in all available forms, including but not limited to, Phone, Email and In-person contact, as depicted in step (620). The User is also presented with all available items for the other Request Types (Product Samples, Patient Education and Product Information), as depicted in step (620). During step (620), the user is also presented with a variety of General Information for the Disease State this product is used to treat. The user views or checks off the desired items and/or Sales Contact Options, as depicted in step (624). Lastly, if a product survey exists (626), the user is asked to fill out a short product survey created by the manufacturer, as depicted in step (627). Upon completion of the product survey, all selected requested items/Sales Contact options will be added to the cart awaiting checkout by the user, as depicted in step (628). If no product survey exists (626), all selected requested items/Sales Contact options will be added to the cart awaiting checkout by the user, as depicted in step (628).

### Privacy and Communications:

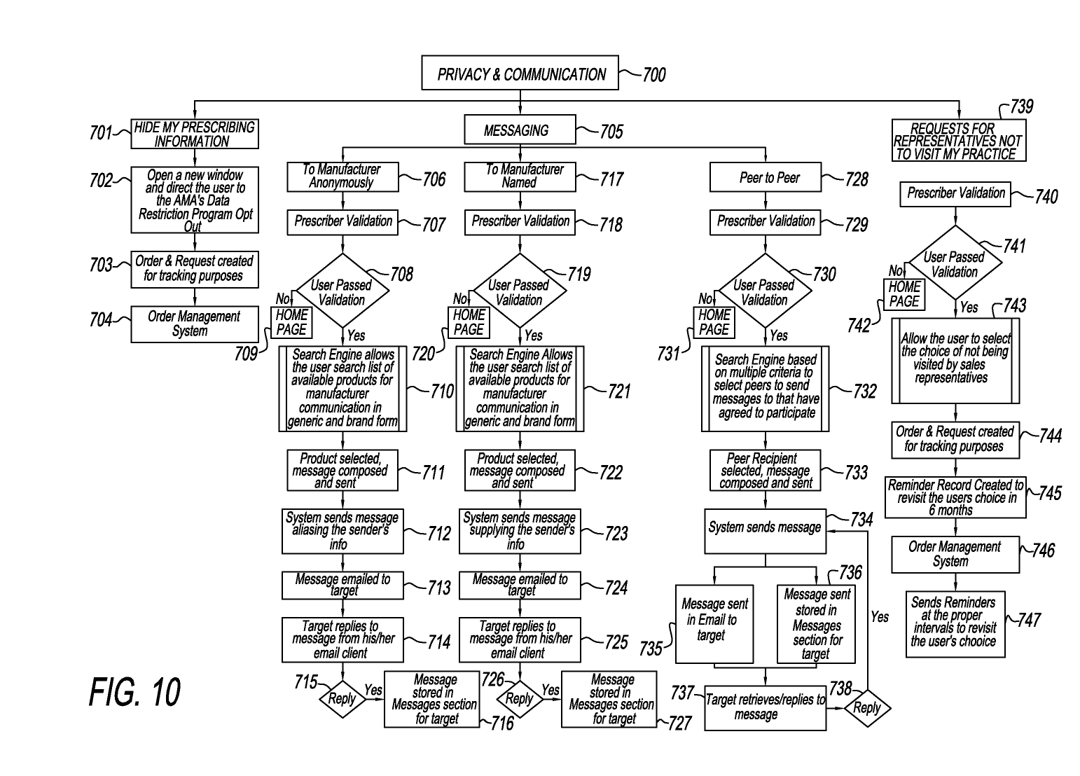

FIG. 10 is a flow chart illustrating a preferred embodiment the process of requests related to Privacy and Communications (700). As shown in FIG. 10, the user may choose to hide their prescribing information (701). If the user elects to hide their prescribing information, a new window opens up and directs the user to the AMA's Data Restriction Program Opt Out, as depicted in step (702). Once at the AMA's Data Restriction Program Opt Out, an order and request is created for tracking purposes, as depicted in step (703), and directed to the Order Management System, as depicted in step (704).

A Messaging function (705) is also available to the user. The user may use the Messaging function to communicate with a Manufacturer Anonymously (706) or be Named to the Manufacturer (717). Whether the user is anonymous or named to the manufacturer, the user proceeds to a Prescriber Validation step, as depicted in steps (707,718). If the user does not successfully pass the validation step, the user is directed back to the Home Page, as depicted in steps (709, 720). If the user successfully passes the validation step, the search engine allows the user to search lists of available products for manufacturer communications in generic and brand form, as depicted in steps (710, 721). Once Product(s) are selected by the user, a message is composed and sent to the manufacturer, as depicted in steps (711, 722). If the user is anonymous, the system sends the message to the manufacturer aliasing the sender's/user's information, as depicted in step (712). If the user is named, the system sends the message to the manufacturer supplying the sender's/user's information, as depicted in step (723). Whether the user is anonymous or named, a message is then emailed to the target, as depicted in steps (713, 724). The target replies to the message from his/her email, as depicted in steps (714, 725). If a reply is generated, as depicted in steps (715, 726), the message is stored in Messages section for the target, as depicted in steps (716, 727).

The user may use the Messaging function to communicate with a colleague using the Peer to Peer feature (728). The user proceeds to a Prescriber Validation step, as depicted in step (729). If the user does not successfully pass the validation step, the user is directed back to the Home Page, as depicted in step (731). If the user successfully passes the validation step, the search engine allows the user to select peers based on multiple criteria to send messages to that have agreed to participate, as depicted in step (732). Once Peer Recipient(s) are selected by the user, a message is composed and sent to the peers, as depicted in step (733). The system sends the message to the peers, as depicted in step (734), via emailed to the target, as depicted in step (735), or the message is stored in the Messages section for targeted peers, as depicted in step (736). The targeted peers may retrieve the message or reply to the message, as depicted in step (737). If a reply is generated by the targeted peers, as depicted in step (738), the system sends the generated reply to the user, as depicted in step (738).

As shown in FIG. 10, the user may make Requests for Representatives (of the Manufacturers) Not to Visit their Practice (739). The user proceeds to a Prescriber Validation step, as depicted in step (740). If the user does not successfully pass the validation step (741), the user is directed back to the Home Page, as depicted in step (742). If the user successfully passes the validation step, the system allows the user to select the choice of not being visited by sales representatives, as depicted in step (743). An Order and Request are created for tracking purposes, as depicted in step (744). A Reminder Record is created to revisit the user's choice in 6 months, as depicted in step (745), and directed to the Order Management System, as depicted in step (746), which sends reminders at the proper intervals to revisit the user's choice, as depicted in step (747).

### Industry Research:

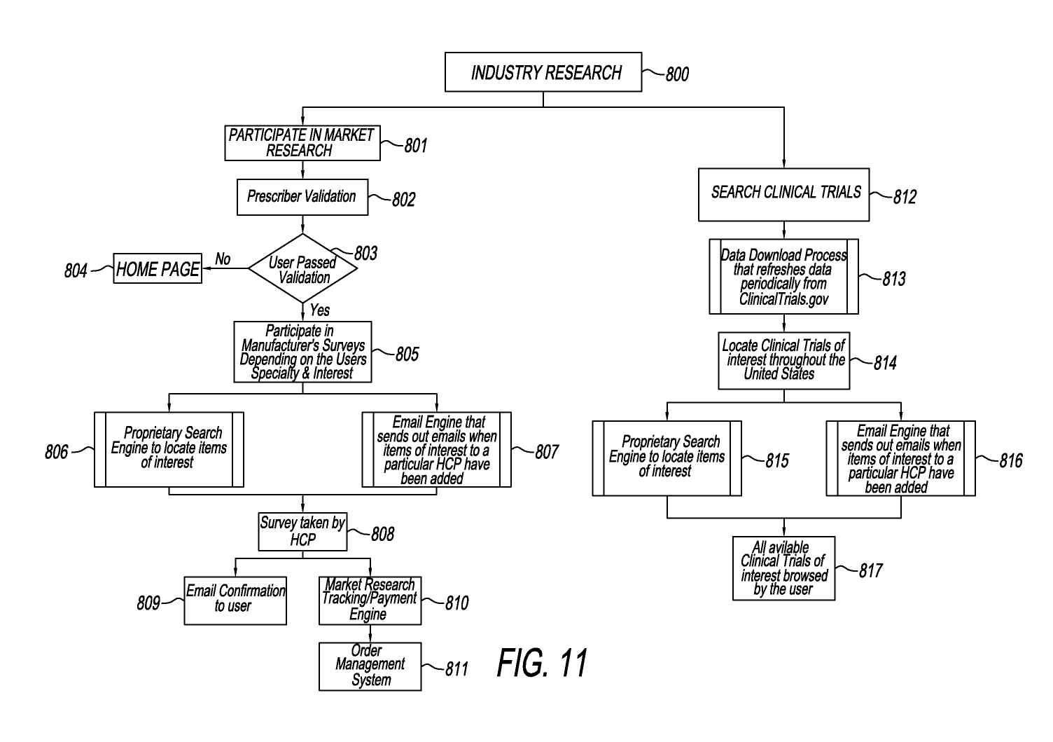

FIG. 11 is a flow chart illustrating a preferred embodiment of the process of requests related to Industry Research (800). As shown in FIG. 11, the user may choose to participate in market research, as depicted in step (801). The user proceeds to a Prescriber Validation step, as depicted in step (802). If the user does not successfully pass the validation step (803), the user is directed back to the Home Page, as depicted in step (804). If the user successfully passes the validation step (803), the user may participate in Manufacturer's Surveys Depending on the Users Specialty & Interest, as depicted in step (805). The user may use a Proprietary Search Engine to locate items of interest, as depicted in step (806), or may elect to have an Email Engine send out emails when items of interest to a particular HCP have been added, as depicted in step (807). After a survey is taken by HCP, as depicted in step (808), an email confirmation is sent to the user, as depicted in step (809) or, in the alternative, a market research tracking/Payment engine request is directed to the Order Management System, as depicted in step (811).

The user may use the Industry Research (800) function to search for Clinical Trials, as depicted in step (812). A Data Download Process that refreshes data periodically, as depicted in step (813), is utilized to locate clinical trials of interest throughout the United States, as depicted in step (814). The user may use a Proprietary Search Engine to locate items of interest, as depicted in step (815), or may elect to have an Email Engine send out emails when items of interest to a particular HCP have been added, as depicted in step (816). The user may then browse all available clinical trials of interest, as depicted in step (817).

### Validation Logic:

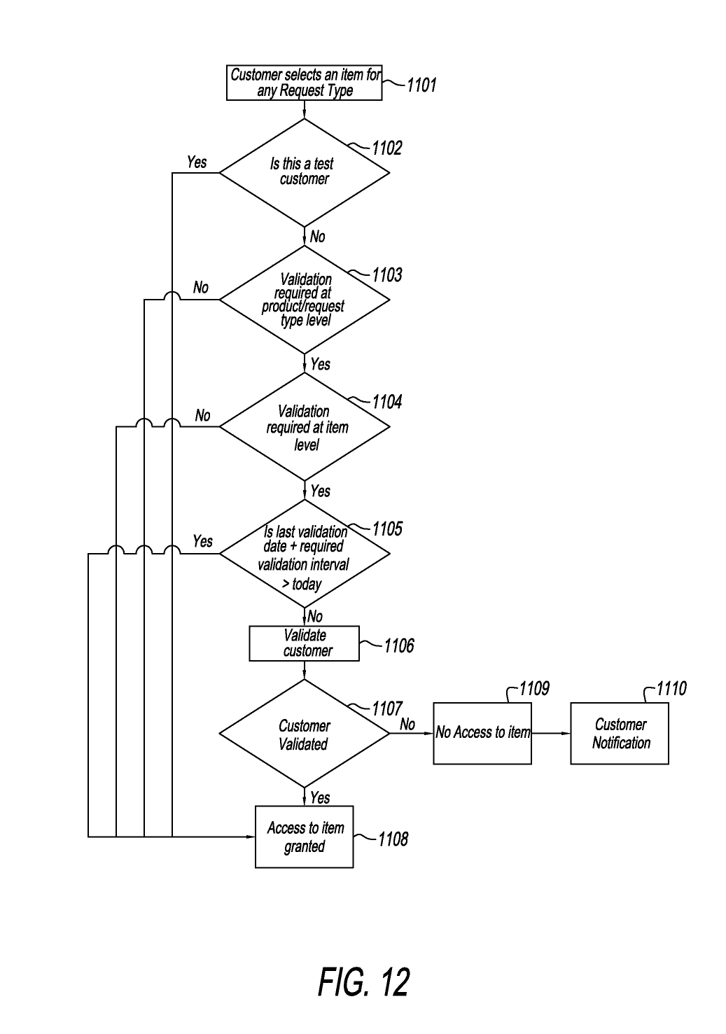

FIG. 12 is a flow chart illustrating a preferred embodiment of the Validation Logic process. The Validation Logic process occurs for all the Requests in the cart. As shown in FIG. 12, the Validation Logic process is initiated when the customer/user selects an item for any Request type, as depicted in step (1101). Once the customer/user selects an item for any Request type, the system determines if the customer/user is a test customer/user, as depicted in step (1102). If the customer/user is a test customer/user, the system grants access to item, as depicted in step (1108). If the customer/user is not a test customer/user, the system determines whether validation is required at the product/request type level, as depicted in step (1103). If validation is not required at the product/request type level, the system grants access to item, as depicted in step (1108). If validation is required at the product/request type level, the system determines whether validation is required at the item level, as depicted in step (1104). If validation is not required at the item level, the system grants access to item, as depicted in step (1108). If validation is required at the item level, the system determines whether the last validation date and required validation interval is greater than the current date, as depicted in step (1105). If the last validation date and required validation interval is greater than the current date, the system grants access to item, as depicted in step (1108). If the last validation date and required validation interval is not greater than the current date, the system will proceed to validate the customer, as depicted in step (1106, 1107). If the customer is successfully validated, the system grants access to item, as depicted in step (1108). If the customer is not successfully validated, access to the item is not granted, as depicted in step (1109) and the customer is notified that access to the item is denied, as depicted in step (1110).

### Validation Process:

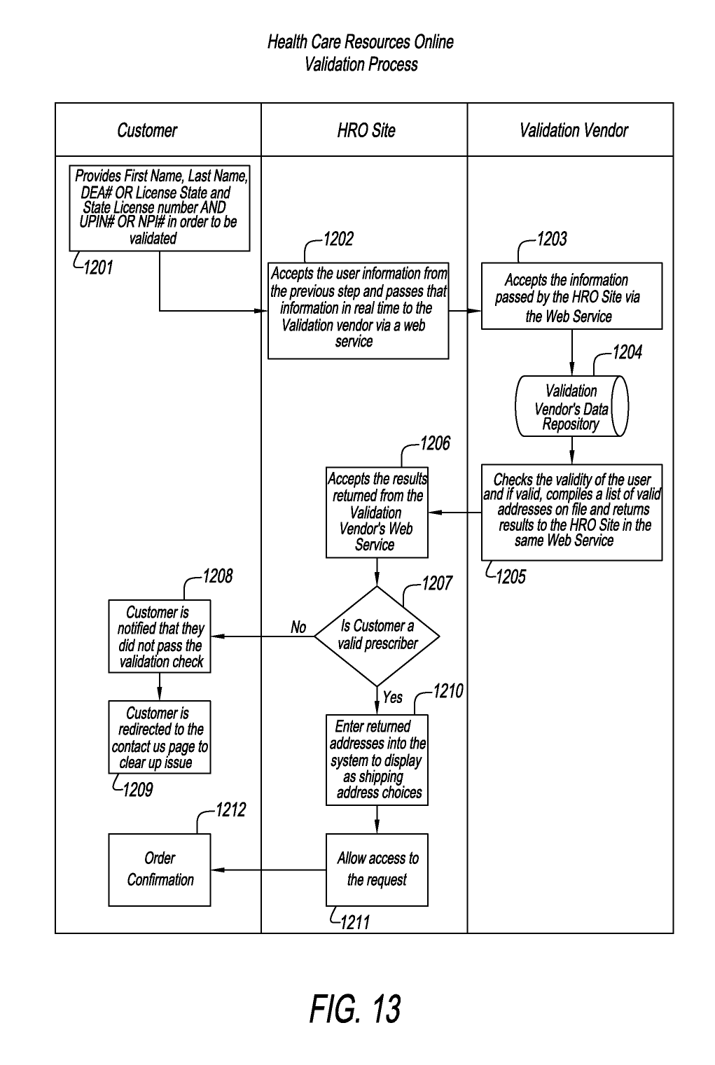

FIG. 13 is a flow chart illustrating a preferred embodiment of the Validation Process. The Validation Process occurs for all the Requests in the cart. As shown in FIG. 13, the Validation Process is initiated when the user/customer provides the customer/user's first name, last name, DEA number or license state and state license number and UPIN# or NPI# in order to be validated, as depicted in step (1201). The HRO Site accepts the information entered by the user and passes the information in real time to the Validation vendor via a web service, as depicted in step (1202). The Validation Vendor accepts the information passed by the HRO site via the Web Service, as depicted in step (1203). The Validation Vendor uses its Data Repository to check the validity of the user, and if valid, compiles a list of valid addresses on file and returns the results to the HRO Site via the same Web Service, as depicted in steps (1204, 1205). The HRO Site accepts the results returned from the Validation Vendor's Web Service to determine whether the customer/use is a valid prescriber, as depicted in steps (1206, 1207). If the user/customer is not a valid prescriber, the customer is notified that they did not pass the validation check and the customer is redirected to the contact us page to resolve any issues, as depicted in steps (1208, 1209). If the user/customer is determined to be a valid prescriber, the customer/user's returned addresses are displayed to the user as shipping address choices, as depicted in step (1210). Lastly, the user is allowed access to the request and an order confirmation is generated, as depicted in steps (1211, 1212).

### Decile Limitation Logic and Process:

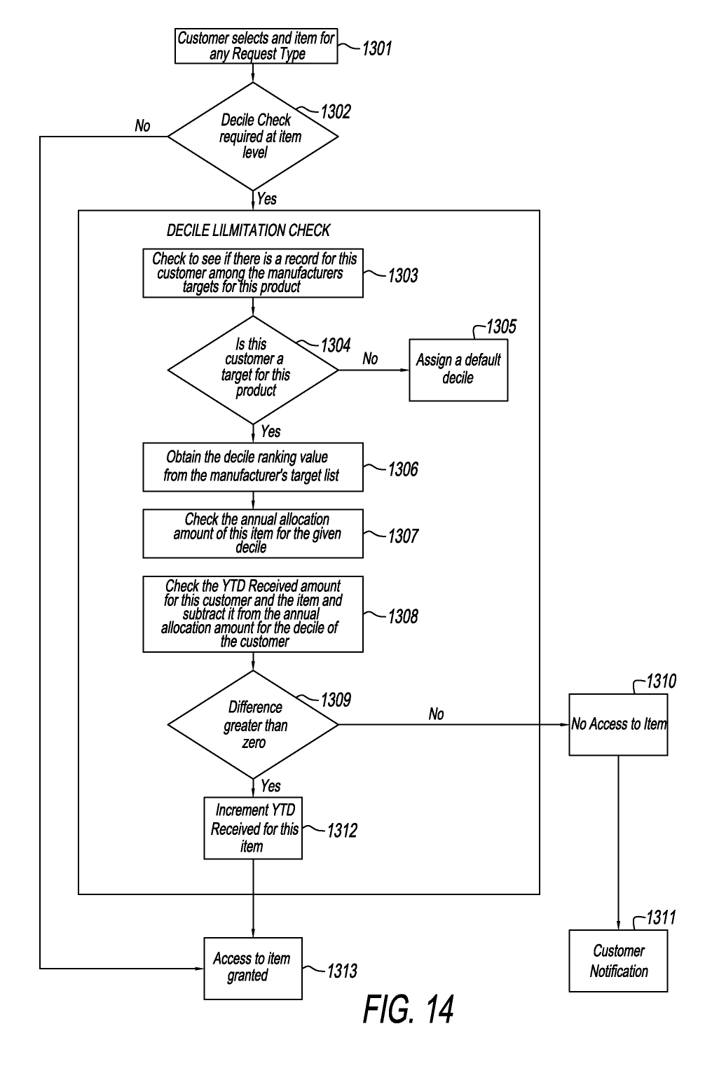

FIG. 14 is a flow chart illustrating a preferred embodiment of the Decile Limitation Logic and Process. The Decile Limitation Logic and Process occurs for all the Requests in the order except Sales Contact requests. For Sales Contact requests, the decile is checked before populating the choices of Sales Contact for the user. The decile determination process is the same. The difference is that there will be certain contact methods available per each decile. No Sales Contact may be allowed at all for the user's decile. The system checks the limitations for the user's decile and only populates the allowable contact methods for user selection if any.

As shown in FIG. 14, the Decile Limitation Logic and Process is initiated when the user/customer selects an item for any Request type, as depicted in step (1301). If a decile check is not required at the item level, access to the item is granted to the user/customer, as depicted in steps (1302, 1313). If a decile check is required at the item level, the system checks to see if there is a record for this user/customer among the manufacturer's targets for the specific product, as depicted in steps (1302, 1303). The system also determines if the user/customer is a target for the specific product, as depicted in step (1304). If the user/customer is not a target for the specific product, a default decile is assigned to the user/customer which is then used to check the annual allocation amount of this item/product for the given decile, as depicted in steps (1305, 1307). If the user/customer is a target for the specific product, the decile ranking value is obtained from the manufacturer's target list which is then used to check the annual allocation amount of this item/product for the given decile, as depicted in steps (1304, 1306, and 1307). The next step in the process is to check the YTD Received amount for the user/customer and the item and subtract it from the annual allocation amount for the decile of the customer, as depicted in step (1308). If the difference is greater than zero, the YTD Received for this item is incremented and access to the item is granted to the user/customer, as depicted in steps (1309, 1312, and 1313). If the difference is not greater than zero, then access to the item is denied to the user/customer and the user/customer is notified, as depicted in steps (1309, 1310, and 1311).

### Checkout Process:

For certain items, the user must be a valid prescriber of Pharmaceuticals in order to receive those certain items. To this end, Prescriber Validation is a check performed in real time with a third party data provider using supplied medical licensing data of the user.

A Decile Limitation Check is a check against a rating system used by the manufacturers. They will assign an annual limit for each item and depending on this rating, we will know the users annual quota for any item. A failed Decile Limitation check is when the user has exceeded their allowable limit of the requested item for this year.

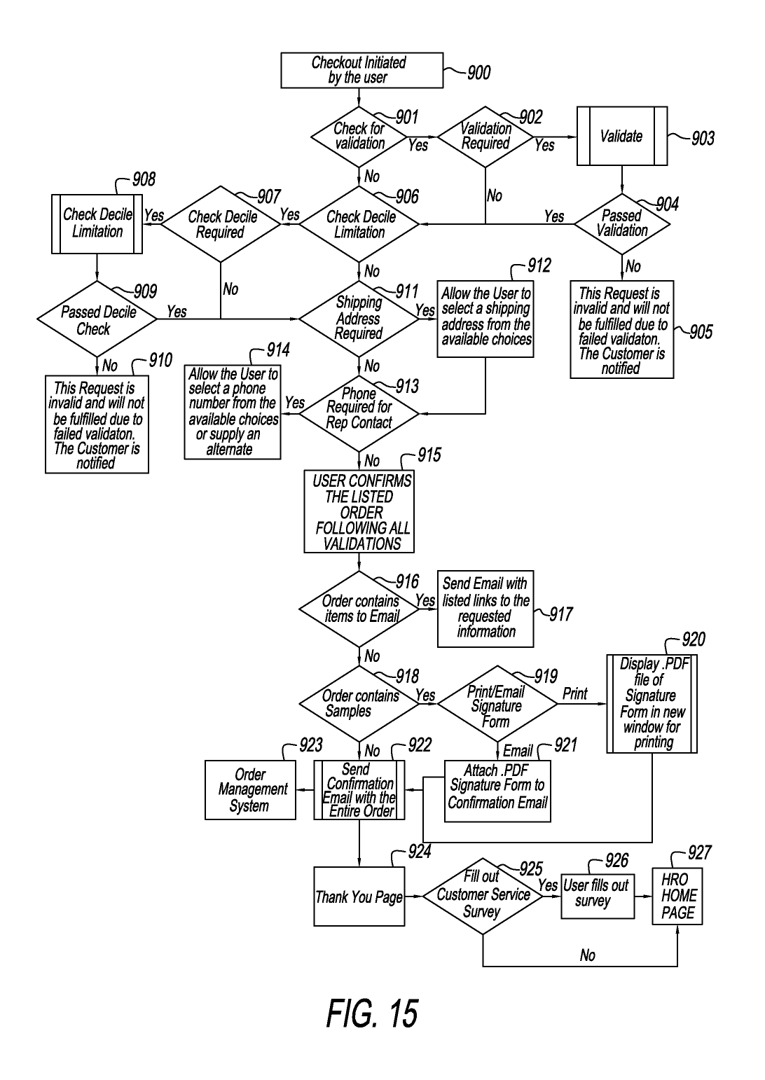

FIG. 15 is a flow chart illustrating a preferred embodiment of the Checkout process. The Checkout Process occurs for all the Requests in the cart. As shown in FIG. 15, once the checkout process is initiated by the user, as depicted in step (900), the system checks if validation is required for the user, as depicted in step (901). If validation is required, as depicted in step (902), the system begins the validation process for the user, as depicted in step (903). Once the user successfully passes Validation, as depicted in step (904), the system will determine if a Decile Limitation Check is required, as depicted in step (906). If the user does not successfully pass Validation, the user will be notified that the Request is invalid and will not be fulfilled, as depicted in step (905). If validation is not required, the system will determine if a Decile Limitation Check is required for the user, as depicted in step (906). If a Decile Limitation Check is required, as depicted in step (907) the system will check the Decile Limitation of the user, as depicted in step (908). As depicted in step (909), the system will determine if the user has successfully passed the Decile Check. If the user does not successfully pass the Decile Limitation Check, the user will be notified that the Request is invalid and will not be fulfilled, as depicted in step (910). If the user passes the Decile Limitation Check for the item or if a Decile Limitation Check is not required, the system will determine whether a shipping address is required, as depicted in step (911). If a shipping address is required, the system will allow the user to select a shipping address from the available choices, as depicted in step (912). Once the user selects a shipping address or in the event a shipping address is not required, the system will determine if a phone number is required from the user to be contacted by a Manufacturer's Representative, as depicted in step (913). If a phone number is required, the system allows the user to select a phone number from the available choices or supply an alternate contact phone number, as depicted in step (914). If a phone number is not required from the user, the user confirms the listed order following all validations, as depicted in step (915). If the order contains items to be sent to the user via email, as depicted in step (916), the system will send an email to the user with listed links to the requested information, as depicted in step (917). If the order does contain items which can not be sent to the user via email e.g. product samples (as depicted in step (918), the system will generate a Signature Form to be executed by the user, as depicted in step (919). The system will display a PDF file of the Signature Form in a new window on the user's computer to allow the user to print the Signature Form, as depicted in step (920). Alternatively, the system can attach the Signature Form to a confirmation email to be sent to the user, as depicted in step (921).

The system will send a confirmation email to the user detailing the user's entire order, as depicted in step (922). The system will then place the user's order with the system's Order Management System, as depicted in step (923), and generate a Thank You Page, as depicted in step (924). Lastly, if a Customer Service survey exists, the user is asked to fill out a Customer Service survey, as depicted in steps (925, 926). If no customer service survey exists or, alternatively, upon completion of the Customer Service survey, the user is directed to the HRO Home Page, as depicted in step (927).

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A system for assisting a healthcare professional comprising;
a static information repository;
an information component, wherein said information component maintains said static information repository;
an authentication module, wherein said authentication module authenticates a healthcare professional based on an authentication information retrieved from said static information repository and based on input from said healthcare professional; and
a presentation component, wherein said presentation component collects a selection input from said healthcare professional and returns an information output to said healthcare professional, wherein said information output is generated by said information component.

2. The system for assisting a healthcare professional of claim 1, wherein said static information repository contains factual drug information selected from a group comprised of drug manufacturer information, statutorily required drug disclosure information, test results data, promotional program information, government statutory information, patient education materials, indigent patient support, form document information, or any combination thereof.

3. The system for assisting a healthcare professional of claim 2, wherein said information component is further comprised of data collector, wherein said data collector is capable of communicating with a plurality of external information sources to obtain said factual drug information and said authentication information, and wherein said information component stores said factual drug information within said static information repository.

4. The system for assisting a healthcare professional of claim 1, wherein said information output is dispatched to said healthcare provider via a computer based network mail.

5. The system for assisting a healthcare professional of claim 1, wherein said static information repository is a conventional database.

6. The system for assisting a healthcare professional of claim 1, wherein said section input on said presentation component is organized in a hierarchical relationship.

7. The healthcare provider assistance system of claim 2, wherein said healthcare provider is able to state a preference in said information component concerning a contact by a sales representative or a pharmaceutical representative to said healthcare provider.

8. The healthcare provider assistance system of claim 7, wherein said information component obtains a set of privacy rules for said healthcare providers and for said drug manufacturers from said static information repository.

9. The healthcare provider assistance system of claim 2, wherein said static information repository is able to store an industry feedback concerning said factual drug information.

10. The healthcare provider assistance system of claim 2, wherein said information output is a document having a PDMA compliant information, wherein said PDMA compliant information is obtained from said static information repository by said information component.

11. The healthcare provider assistance system of claim 10, wherein said document has a format required by said drug manufacturer, wherein said format is obtained from said static information repository by said information component.

12. The healthcare provider assistance system of claim 10, wherein said document contains a privacy supplement, said privacy supplement specifying a privacy preference by said healthcare provider concerning a solicitation contact by said drug manufacturer.

13. The healthcare provider assistance system of claim 12, wherein said privacy supplement is customized based on a privacy format of said drug manufacturer, wherein said privacy format is obtained from said static information repository by said information component.

14. The healthcare provider assistance system of claim 1, wherein said information output is generated by a checkout component.

15. The healthcare provider assistance system of claim 2, wherein said selection input is selected from said static information repository.

16. A method of providing healthcare information procurement comprising the steps of;
aggregation of a factual drug data within a static information repository;
a selection by a healthcare professional of said factual drug information;
an authentication of said healthcare provider authentication information within a presentation component;
generation of a PDMA compliant information output directed at a pharmaceutical manufacturer based on selection by said health care professional wherein the PDMA compliance information is obtained from said static information repository by an information aggregator.

17. The method of providing healthcare information procurement of claim 16, further comprising step of selection of said factual drug information from a group comprised of statutorily required drug disclosure information, drug manufacturer information test results data, promotional program information, government statutory information, form document information, patient education materials, indigent patient support, or a combination thereof.

18. The method of providing healthcare information procurement of claim 16, further comprising a checkout step for said selection.

19. The method of providing healthcare information procurement of claim 16, wherein the authentication step further comprises a step of verification of said authentication information healthcare professional's credentials, wherein said authentication information is obtained from an external information source.

20. The method of providing healthcare information procurement of claim 16, further comprising a step of generating a PDMA compliant document for said healthcare professional, wherein said PDMA compliant document is based on said PDMA compliant information output.

21. The method of providing drug procurement assistance of claim 20, further comprising a step of obtaining a quantity of a drug sample by said healthcare provider, wherein said drug sample is obtained based on said PDMA compliant document.

22. The method of providing drug procurement assistance of claim 20, further comprising a step of obtaining a quantity of a drug sample from a drug sample clearinghouse, based on information contained in said PDMA compliant document.

23. The method of providing drug procurement assistance of claim 16, wherein said information manager regularly prompts said healthcare provider to update a privacy selection within said static information repository.

24. The method of providing drug procurement assistance of claim 16, further comprising a step of providing feedback on said factual drug information by said healthcare provider.

25. A system useful for obtaining medical information comprising:
a static information repository;
an information component, wherein said information component maintains said static information repository;
a presentation component, wherein said presentation component collects a selection input from a user and returns an information output to said user, wherein said information output is generated by said information component.
